(19) United States
(12) Patent Application Publication
(10) Pub. No.: US 2011/0083078 A1
(43) Pub. Date: Apr. 7, 2011

(54) MOBILE TERMINAL AND BROWSING METHOD THEREOF

(76) Inventor: Seok-Hoon JU, Seoul (KR)

(21) Appl. No.: 12/728,761

(22) Filed: Mar. 22, 2010

(30) Foreign Application Priority Data
Oct. 1, 2009 (KR) 10-2009-0094140

(51) Int. Cl. G06F 3/048; G06F 17/30

(52) U.S. Cl. 715/738; 707/769; 715/769; 715/782; 707/E17.014

(57) ABSTRACT

A mobile terminal may be provided that accesses the web through a browser, searches data including a search keyword inputted by a user on the accessed web, displays a list of the searched results, loads web pages linked to at least one or more search results from among the searched results, and displays the loaded web pages on a display screen when a particular event is generated while displaying the search results list.

This application claims priority and benefit from Korean Application No. 10-2009-0094140, filed Oct. 1, 2009, the subject matter of which is incorporated herein by reference.

### BACKGROUND 1. Field

Embodiments of the present invention may relate to a mobile terminal and a browsing method thereof for automatically loading a web page linked to a predetermined number of results from among results retrieved from the web.

2. Background

A terminal such as a personal computer, a notebook, a portable (or mobile) phone, and the like, may be allowed to capture still images or moving images, play music and/or video files, play games, receive broadcast and the like, so as to be implemented as an integrated multimedia player.

Terminals may be classified based on mobility into two types, such as a mobile terminal and a stationary terminal. The mobile terminal may be further classified into two types (such as a handheld terminal and a vehicle mount terminal) based on whether or not the terminal may be directly carried by a user.

A mobile terminal may access the web through a wireless communication, and may search for desired information on the accessed web.

### BRIEF DESCRIPTION OF THE DRAWINGS

Arrangements and embodiments may be described in detail with reference to the following drawings in which like reference numerals refer to like elements and wherein:

FIG. 1 is a block diagram illustrating a mobile terminal associated with an example embodiment of the present invention;

FIG. 2A is a front perspective view illustrating a mobile terminal associated with an example embodiment;

FIG. 2B is a rear perspective view illustrating a mobile terminal associated with an example embodiment;

FIG. 3 is a front view of a mobile terminal for explaining an operation state of a mobile terminal associated with an example embodiment;

FIG. 4 is a flow chart illustrating a browsing method of a mobile terminal associated with an example embodiment;

FIGS. 5 through 8 are views illustrating examples in which a mobile terminal associated with an example embodiment browses the web or the Internet;

FIG. 9 is a view illustrating an example in which a mobile terminal selects and displays one of the web pages displayed on a polyhedron;

FIGS. 10a and 10b are views illustrating an example in which a mobile terminal controls a display screen based on a touch drag input;

FIG. 11 is a view illustrating an example in which a mobile terminal performs a multi-search;

FIG. 12 is an example illustrating an execution screen of a 3D browser in a mobile terminal associated with an example embodiment;

FIGS. 13A-13H are examples illustrating adding to favorites on a mobile terminal associated with an example embodiment; and

FIGS. 14A-14B are views illustrating an execution screen of a 3D browser in a mobile terminal associated with an example embodiment and an unfolded view thereof.

### DETAILED DESCRIPTION

A mobile terminal may be described with reference to the accompanying drawings. A suffix “module” or “unit” used for constituent elements disclosed in the following description is merely intended for easy description of the specification, and the suffix itself does may give any special meaning or function.

A mobile terminal may include a portable phone, a smart phone, a laptop computer, a digital broadcast terminal, a personal digital assistant (PDA), a portable multimedia player (PMP), a navigation, and/or the like. However, it may be easily understood by those skilled in the art that a configuration according to the example embodiments disclosed herein may be applicable to stationary terminals such as a digital TV, a desktop computer, and/or the like, as well as mobile terminals.

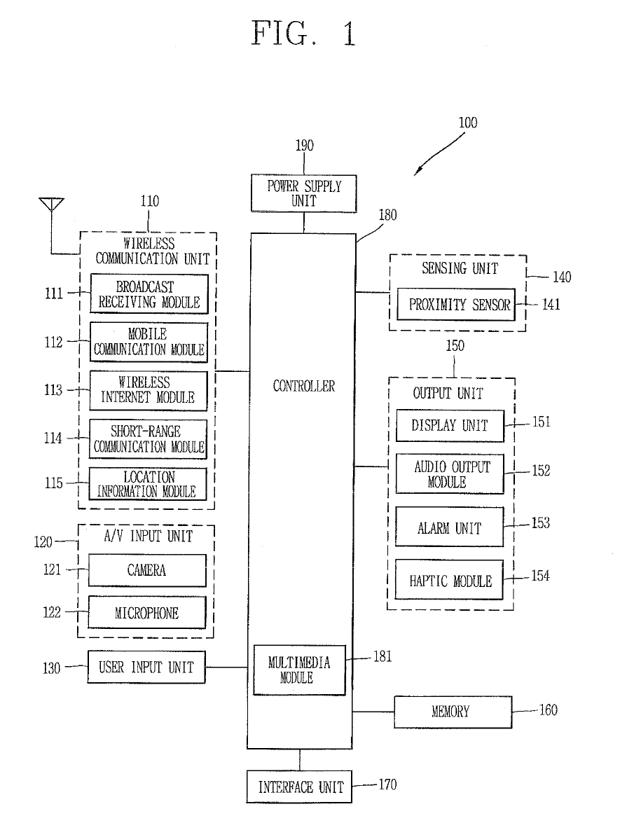

FIG. 1 is a block diagram illustrating a mobile terminal associated with an example embodiment of the present invention. Other arrangements and embodiments may also be within the scope of the present invention.

The mobile terminal 100 may include a wireless communication unit 110, an Audio/Video (A/V) input unit 120, a user input unit 130, a sensing unit 140, an output unit 150, a memory 160, an interface unit 170, a controller 180, a power supply unit 190 and/or the like. However, the elements shown in FIG. 1 are not necessarily required, and the mobile terminal may be implemented with a greater number or a less number of elements than those shown in FIG. 1.

The wireless communication unit 110 may include one or more elements allowing radio communication between the mobile terminal 100 and a wireless communication system, and/or allowing radio communication between the mobile terminal 100 and a network in which the mobile terminal 100 is located. For example, the wireless communication unit 110 may include a broadcast receiving module 111, a mobile communication module 112, a wireless Internet module 113, a short-range communication module 114, a location info nation module 115, and/or the like.

The broadcast receiving module 111 may receive broadcast signals and/or broadcast associated information from an external broadcast management server through a broadcast channel.

The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmit to the mobile terminal 100. The broadcast signal may include a TV broadcast signal, a radio broadcast signal and a data broadcast signal as well as a broadcast signal in a form that a data broadcast signal is combined with the TV or radio broadcast signal.

The broadcast associated information may be information regarding a broadcast channel, a broadcast program, a broadcast service provider, and/or the like. The broadcast associated information may also be provided through a mobile communication network, and in this example, the broadcast associated information may be received by the mobile communication module 112.

The broadcast signal may be provided in various forms. For example, the broadcast signal may be provided in the form of an electronic program guide (EPG) of digital multimedia broadcasting (DMB), an electronic service guide (ESG) of digital video broadcast-handheld (DVB-H), and/or the like.

The broadcast receiving module 111 may receive a broadcast signal using various types of broadcast systems. The broadcast receiving module 111 may receive a digital broadcast signal using a digital broadcast system such as digital multimedia broadcasting-terrestrial (DMB-T), digital multimedia broadcasting-satellite (DMB-S), media forward link only (MediaFLO), digital video broadcast-handheld (DVB-H), integrated services digital broadcast-terrestrial (ISDB-T), and/or the like. The broadcast receiving module 111 may be suitable for every broadcast system that provides a broadcast signal as well as the above-mentioned digital broadcast systems.

The broadcast signal and/or broadcast-associated information received through the broadcast receiving module 111 may be stored in the memory 160.

The mobile communication module 112 may transmit and/or receive a radio signal to and/or from at least one of a base station, an external terminal or a server over a mobile communication network. The radio signal may include a voice call signal, a video call signal and/or various types of data according to text and/or multimedia message transmission and/or reception.

The wireless Internet module 113 may be a module for supporting wireless Internet access. The wireless Internet module 113 may be built-in or externally installed to the mobile terminal 100. The wireless Internet module 113 may use a wireless Internet access technique including a WLAN (Wireless LAN), Wi-Fi, Wibro (Wireless Broadband), Wimax (World Interoperability for Microwave Access), HSDPA (High Speed Downlink Packet Access), and/or the like.

The short-range communication module 114 may support a short-range communication. The short-range communication module 114 may use a short-range communication technology including Bluetooth, Radio Frequency IDentification (RFID), Infrared Data Association (IrDA), Ultra WideBand (UWB), ZigBee, and/or the like.

The location information module 115 may check or acquire a location of the mobile terminal. A GPS module may be one example of a type of location information module.

The A/V (audio/video) input unit 120 may receive an audio or video signal, and the A/V (audio/video) input unit 120 may include a camera 121 and a microphone 122. The camera 121 may process an image frame, such as a still picture or a video, obtained by an image sensor in a video phone call or an image capturing mode. The processed image frame may be displayed on a display unit 151.

The image frames processed by the camera 121 may be stored in the memory 160 and/or may be transmitted to an external device through the wireless communication unit 110. Two or more cameras 121 may be provided according to a use environment of the mobile terminal.

The microphone 122 may receive an external audio signal through a microphone in a phone call mode, a recording mode, a voice recognition mode, and/or the like, and may process the audio signal into electrical voice data. The processed voice data may be converted and outputted into a format that is transmittable to a mobile communication base station through the mobile communication module 112 in the phone call mode. The microphone 122 may implement various types of noise canceling algorithms (or noise reducing algorithms) to cancel or reduce noise generated in a procedure of receiving the external audio signal.

The user input unit 130 may generate input data to control an operation of the mobile terminal. The user input unit 130 may be configured by including a keypad, a dome switch, a touch pad (pressure/capacitance), a jog wheel, a jog switch, and/or the like.

The sensing unit 140 may detect a current status of the mobile terminal 100 such as an opened state or a closed state of the mobile terminal 100, a location of the mobile terminal 100, an orientation of the mobile terminal 100, and/or the like. The sensing unit 140 may generate a sensing signal for controlling operation of the mobile terminal 100. For example, when the mobile terminal 100 is a slide phone type, the sensing unit 140 may sense an opened state or a closed state of the slide phone. Further, the sensing unit 140 may take charge of a sensing function associated with whether or not power is supplied from the power supply unit 190, and/or whether or not an external device is coupled to the interface unit 170. The sensing unit 140 may also include a proximity sensor 141.

The output unit 150 may provide an output for an audio signal, a video signal, and/or an alarm signal. The output unit 150 may include the display unit 151, an audio output module 152, an alarm unit 153, a haptic module 154, and/or the like.

The display unit 151 may display (output) information processed in the mobile terminal 100. For example, when the mobile terminal 100 is in a phone call mode, the display unit 151 may display a User Interface (UI) and/or a Graphic User Interface (GUI) associated with a call. When the mobile terminal 100 is in a video call mode or an image capturing mode, the display unit 151 may display a captured image and/or a received image, a UI or a GUI.

The display unit 151 may include at least one of a Liquid Crystal Display (LCD), a Thin Film Transistor-LCD (TFT-LCD), an Organic Light Emitting Diode (OLED) display, a flexible display, and/or a three-dimensional (3D) display.

The displays may be configured with a transparent or optical transparent type to allow viewing of an exterior through the display unit, which may be called transparent displays. An example of a transparent display may include a transparent LCD (TOLED), and/or the like. Under this configuration, a user can view an object positioned at a rear side of a terminal body through a region occupied by the display unit 151 of the terminal body.

The display unit 151 may be implemented as two or more display units according to a configured aspect of the portable terminal 100. For example, a plurality of the display units 151 may be arranged on one surface and may be spaced apart from or integrated with each other, and/or may be arranged on different surfaces.

If the display unit 151 and a touch sensitive sensor (referred to as a touch sensor) have a layered structure therebetween, the structure may be referred to as a touch screen. The display unit 151 may be used as an input device rather than an output device. The touch sensor may be implemented as a touch film, a touch sheet, a touch pad, and/or the like.

The touch sensor may convert changes of a pressure applied to a specific part of the display unit 151, and/or a capacitance occurring from a specific part of the display unit 151, into electric input signals. The touch sensor may sense not only a touched position and a touched area, but also a touch pressure.

When touch inputs are sensed by the touch sensors, corresponding signals may be transmitted to a touch controller (not shown). The touch controller may process the received signals, and then transmit corresponding data to the controller 180. Accordingly, the controller 180 may sense which region of the display unit 151 has been touched.

A proximity sensor 142 may be arranged at an inner region of the portable terminal 100 covered by the touch screen, and/or near the touch screen. The proximity sensor 142 may include a sensor to sense presence or absence of an object approaching a surface to be sensed, and/or an object provided near a surface to be sensed, by using an electromagnetic field or infrared rays without a mechanical contact. The proximity sensor 142 may have a longer lifespan and a more enhanced utility than a contact sensor.

The proximity sensor 142 may include an optical transmission type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and/or so on. When the touch screen is implemented as a capacitance type, proximity of a pointer to the touch screen may be sensed by changes of an electromagnetic field. In this example, the touch screen (touch sensor) may be categorized as a proximity sensor.

Hereinafter, for ease of explanation, a status that the pointer is positioned to be proximate to the touch screen without contact may be referred to as ‘proximity touch’, whereas a status that the pointer substantially comes in contact with the touch screen may be referred to as ‘contact touch’. For the position corresponding to the proximity touch of the pointer on the touch screen, such position corresponds to a position where the pointer faces perpendicular to the touch screen upon the proximity touch of the pointer.

The proximity sensor may sense proximity touch and proximity touch patterns (e.g., distance, direction, speed, time, position, moving status, etc.). Information relating to the sensed proximity touch and the sensed proximity touch patterns may be output onto the touch screen.

The audio output module 152 may output audio data received from the wireless communication unit 110 and/or stored in the memory 160, in a call-receiving mode, a call-placing mode, a recording mode, a voice recognition mode, a broadcast reception mode, and/or so on. The audio output module 152 may output audio signals relating to functions performed in the portable terminal 100 (e.g., sound alarming a call received or a message received, and so on). The audio output module 152 may include a receiver, a speaker, a buzzer, and/or so on.

The alarm 153 may output signals notifying occurrence of events from the portable terminal 100. The events occurring from the portable terminal 100 may include call received, message received, key signal input, touch input, and/or so on. The alarm 153 may output not only video or audio signals, but also other types of signals such as signals notifying occurrence of events in a vibrational manner. Since the video or audio signals can be output through the display unit 151 or the audio output unit 152, the display unit 151 and the audio output module 152 may be categorized as a part of the alarm 153.

The haptic module 154 may generate various tactile effects that a user may feel. A representative example of the tactile effects generated by the haptic module 154 may include vibration. Vibration generated by the haptic module 154 may have a controllable intensity, a controllable pattern, and/or so on. For example, different vibrations may be output in a synthesized manner and/or in a sequential manner.

The haptic module 154 may generate various tactile effects including not only vibration but also arrangement of pins vertically moving with respect to a skin being touched (contacted), air injection force and/or air suction force through an injection hole or a suction hole, touch by a skin surface, presence or absence of contact with an electrode, effects by stimulus such as an electrostatic force, reproduction of cold or hot feeling using a heat absorbing device or a heat emitting device, and/or the like.

The haptic module 154 may transmit tactile effects (signals) through a user's direct contact, and/or a user's muscular sense using a finger or a hand. The haptic module 154 may be implemented as two or more modules according to configuration of the portable terminal 100.

The memory 160 may store a program for processing and control of the controller 180. The memory 160 may temporarily store input/output data (e.g., phonebook data, messages, still images, video and/or the like). The memory 160 may store data related to various patterns of vibrations and audio output upon touch input on the touch screen.

The memory 160 may be implemented using any type of suitable storage medium including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-only Memory (EEPROM), Programmable Read-only Memory (PROM), magnetic memory, magnetic disk, optical disk, and/or the like. The mobile terminal 100 may operate a web storage that performs a storage function of the memory 160 on the Internet.

The interface unit 170 may interface the portable terminal with external devices. The interface unit 170 may allow data reception from an external device, a power delivery to each component in the mobile terminal 100, and/or data transmission from the mobile terminal 100 to an external device. The interface unit 170 may include, for example, wired/wireless headset ports, external charger ports, wired/wireless data ports, memory card ports, ports for coupling devices having an identification module, audio Input/Output (I/O) ports, video I/O ports, earphone ports, and/or the like.

The identification module may be configured as a chip for storing various information required to authenticate an authority to use the mobile terminal 100, which may include a User Identity Module (UIM), a Subscriber Identity Module (SIM), and/or the like. The device having the identification module (hereinafter referred to as ‘identification device’) may be implemented in a type of smart card. The identification device may be coupled to the portable terminal 100 via a port.

The interface unit 170 may serve as a path for power to be supplied from an external cradle to the mobile terminal 100 when the mobile terminal 100 is connected to the external cradle or as a path for transferring various command signals inputted from the cradle by a user to the mobile terminal 100. Such various command signals or power inputted from the cradle may operate as signals for recognizing that the mobile terminal 100 has accurately been mounted to the cradle.

The controller 180 may control overall operations of the mobile terminal 100. For example, the controller 180 may perform control and processing associated with telephony calls, data communications, video calls, and/or the like. The controller 180 may include a multimedia module 181 that provides multimedia playback. The multimedia module 181 may be configured as part of the controller 180 or as a separate component.

The controller 180 may perform a pattern recognition processing so as to recognize writing or drawing input on the touch screen as text or image.

The power supply unit 190 may provide power required by various components under the control of the controller 180. The provided power may be internal power, external power, and/or a combination thereof.

Various arrangements and embodiments described herein may be implemented in a computer-readable medium using, for example, software, hardware, and/or some combination thereof.

For a hardware implementation, arrangements and embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, micro processors, other electronic units designed to perform the functions described herein, and/or a selective combination thereof. Such arrangements and embodiments may be implemented by the controller 180.

For software implementation, arrangements and embodiments such as procedures and functions may be implemented together with separate software modules each of which may perform at least one of functions and operations. The software codes may be implemented with a software application written in any suitable programming language. The software codes may be stored in the memory 160 and may be executed by the controller 180.

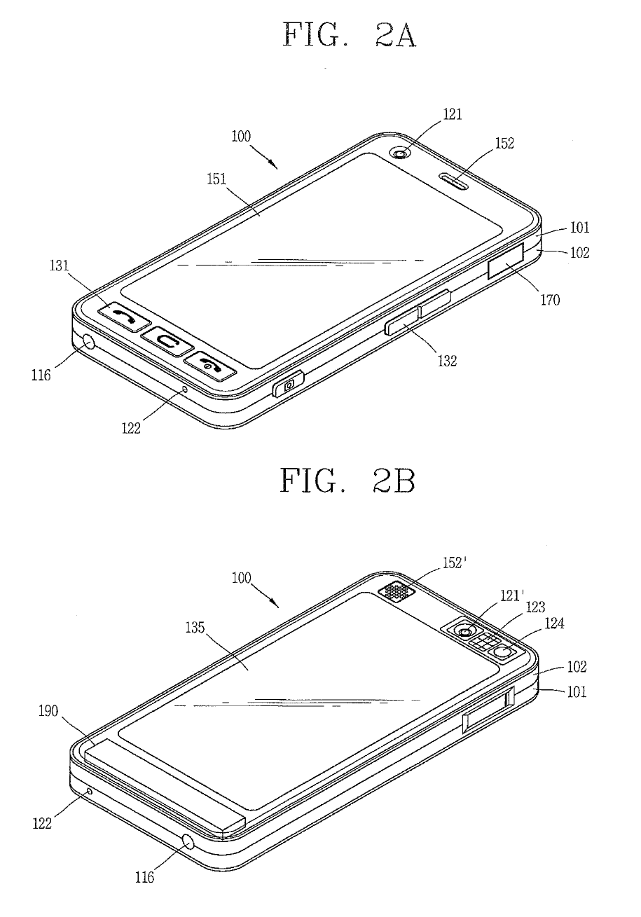

FIG. 2A is a front perspective view of a mobile terminal (or portable terminal) associated with an example embodiment. Other embodiments and configurations may also be provided.

The main terminal 100 as disclosed herein may be provided with a bar-type terminal body. However, embodiments of present invention are not only limited to this type of terminal, but also are applicable to other structures of terminals such as slide type, folder type, swivel type, swing type, and/or the like, in which two and more bodies are combined with each other in a relatively movable manner.

The terminal body may include a case (casing, housing, cover, etc.) forming an appearance of the terminal. In this embodiment, the case may be divided into a front case 101 and a rear case 102. At least one middle case may be additionally provided between the front case 101 and the rear case 102.

The cases may be formed by injection-molding a synthetic resin or may be formed of a metal material such as stainless steel (STS), titanium (Ti), and/or the like.

A display unit 151, an audio output module 152, a camera 121, a user input unit 130 (e.g., user input unit or first manipulation unit 131 and user interface or second manipulation unit 132), a microphone 122, an interface 170, and/or the like may be arranged on the terminal body, and may be mainly provided on the front case 101.

The display unit 151 may occupy most of the front case 101. The audio output unit 152 and the camera 121 may be provided on a region adjacent to one of both ends of the display unit 151, and the user input unit 131 and the microphone 122 may be provided on a region adjacent to the other end thereof. The user interface 132 and the interface 170, and the like, may be provided on a lateral surface of the front case 101 and the rear case 102.

The user input unit 130 may receive a command for controlling operation of the mobile terminal 100, and may include a plurality of manipulation units 131, 132. The manipulation units 131, 132 may be commonly designated as a manipulating portion, and any method may be employed when it is a tactile manner allowing the user to perform manipulation with a tactile feeling.

The content inputted by the manipulation units 131, 132 may be set in various ways. For example, the first manipulation unit 131 may receive a command, such as start, end, scroll, a 3D browser execution, and/or the like, and the second manipulation unit 132 may receive a command, such as a command for controlling a volume level being outputted from the audio output unit 152, and/or switching it into a touch recognition mode of the display unit 151.

FIG. 2B is a rear perspective view illustrating a mobile terminal of FIG. 2A.

As shown in FIG. 2B, a camera 121′ may be additionally mounted on a rear surface of the terminal body, namely the rear case 102. The camera 121′ may have an image capturing direction that is substantially opposite to the direction of the camera 121 as shown in FIG. 2A, and the camera 121′ may have different pixels from those of the first camera 121.

For example, the camera 121 may have a relatively small number of pixels enough not to cause a difficulty when the user captures his or her own face and sends it to the other party during a video call or the like, and the camera 121′ has a relatively large number of pixels since the user often captures a general object that is not sent immediately. The cameras 121, 121′ may be provided in the terminal body in a rotatable and popupable manner.

A flash 123 and a mirror 124 may be additionally provided adjacent to the camera 121′. The flash 123 may illuminate light toward an object when capturing the object with the camera 121′. The mirror 124 may allow the user to look at his or her own face or the like, in a reflected way when capturing himself or herself (in a self-portrait mode) by using the camera 121′.

An audio output unit 152′ may be additionally provided on a rear surface of the terminal body. The audio output unit 152′ together with the audio output unit 152, as shown in FIG. 2A, may implement a stereo function, and may also be used to implement a speaker phone mode during a phone call.

An antenna 116 for receiving broadcast signals may be additionally provided on (or along) a lateral surface of the terminal body. The antenna 116 constituting a broadcast receiving module 111, as shown in FIG. 1, may be provided so as to be pulled out from the terminal body.

A power supply unit 190 for supplying power to the mobile terminal 100 may be mounted on a rear surface of the terminal body. The power supply unit 190 may be configured so as to be incorporated in the terminal body, or may be directly detachable from outside of the terminal body.

A touch pad 135 for detecting a touch may be additionally mounted on the rear case 102. The touch pad 135 may be configured in an optical transmission type similar to the display unit 151. If the display unit 151 is configured to output visual information from both sides of the display unit 151, then the visual information may also be recognized through the touch pad 135. The information outputted from the both sides thereof may be controlled by the touch pad 135. In addition, a display may be additionally provided on the touch pad 135, and a touch screen may also be provided on the rear case 102.

The touch pad 135 may operate in reciprocal relation to the display unit 151 of the front case 101. The touch pad 135 may be provided in parallel on a rear side of the display unit 151. The touch pad 135 may have a same size or a smaller size as the display unit 151.

An operation method of the touch pad 135 in reciprocal relation to the display unit 151 may be described below.

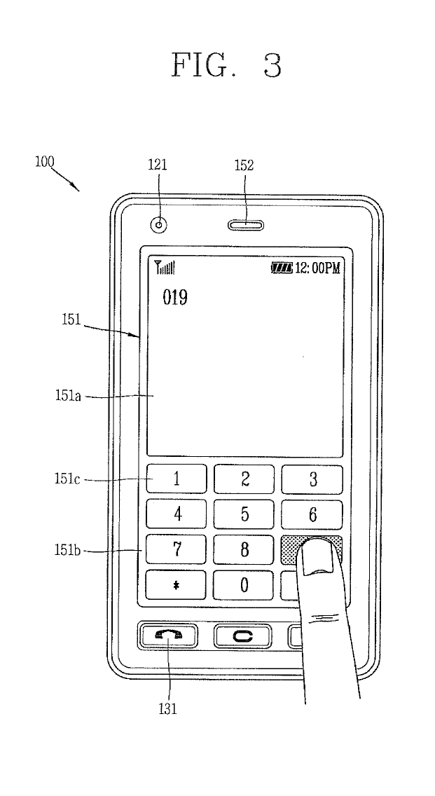

FIG. 3 is a front view of a mobile terminal for explaining an operation state of a mobile terminal associated with an example embodiment. Other embodiments and configurations may also be provided.

Various kinds of visual information may be displayed on the display unit 151. The visual information may be displayed in a form of characters, numerals, symbols, graphics, and/or icons.

For an input of the visual information, at least one of characters, numerals, symbols, graphics, and/or icons may be displayed with a predetermined arrangement so as to be implemented in a form of a keypad. Such a keypad may be referred to as a “soft key.”

FIG. 3 illustrates a view in which a touch applied to a soft key may be inputted through a front surface of the terminal body.

The display unit 151 may operate on an entire region or operate by being divided into a plurality of regions. In the latter example, the plurality of regions may be configured to operate in an associative way.

For example, an output window 151a and an input window 151b may be displayed on an upper portion and a lower portion of the display unit 151, respectively. The output window 151a and the input window 151b may be regions allocated to output or input information, respectively. A soft key 151c on which numerals for inputting phone numbers or the like are displayed may be outputted on the input window 151b. When the soft key 151c is touched, numerals corresponding to the touched soft key may be displayed on the output window 151a. When the first manipulating unit 131 is manipulated, a call connection may be attempted for the phone number displayed on the output window 151a.

Additionally, the display unit 151 or the touch pad 135 may be touch-inputted by a scroll. The user may move an object displayed on the display unit 151, for example, a cursor or a pointer placed on an icon or the like, by scrolling the display unit 151 or the touch pad 135. Moreover, when a finger is moved on the display unit 151 or the touch pad 135, a path being moved by the finger may be visually displayed on the display unit 151. An image displayed on the display unit 151 may be edited.

In an example where the display unit 151 (touch screen) and the touch pad 135 are touched together within a predetermined period of time, one function of the terminal may be executed. As an example of being touched together, a user may clamp a terminal body using a thumb and a forefinger. For one of the above functions, there may be an activation or de-activation for the display unit 151 or the touch pad 135.

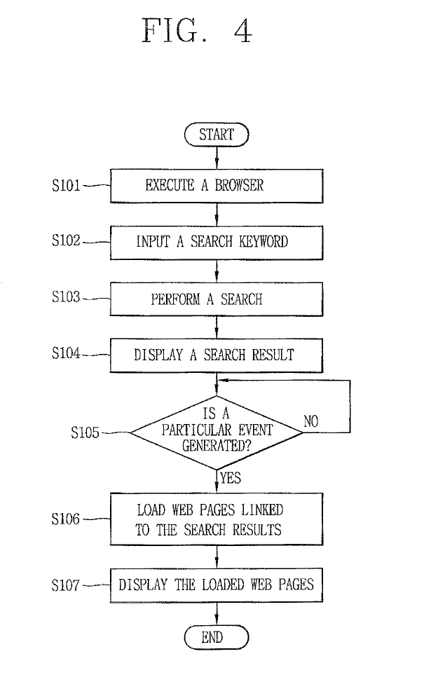

FIG. 4 is a flow chart illustrating a browsing method of a mobile terminal associated with an example embodiment of the present invention. Other operations, orders of operation and embodiments may also be within the scope of the present invention

Referring to FIG. 4, the controller 180 may execute a browser based on a user's input to access the web or Internet (S101). The controller 180 may execute a search engine. The search engine may be software to help the user find desired data on the Internet. For example, if the user selects a browser menu through a menu manipulation, then the controller 180 may execute the browser to access a preset particular site.

Subsequent to executing the browser, the controller 180 may receive a search keyword from the user input unit 130 (S102). For example, when a search keyword input window of the browser is selected, the controller 180 may switch to a text input mode and display a keypad icon on a side of the display screen. When a touch is detected on the displayed keypad icon, the controller 180 may enter data corresponding to the touched position into the search keyword input window.

When the search keyword input window is selected in the web page of a particular site displayed on the browser screen, the controller 180 may switch to a text input mode and enter the search keyword inputted through the user input unit 130 into the search keyword input window of the web page.

After an input of the search keyword is completed, and a search command is inputted, the controller 180 may perform a search using the search engine (S103). For example, when a search command is inputted by the user, the controller 180 may transfer the inputted search keyword to the search engine. The search engine may search data including the inputted search keyword on the web (or Internet). The search engine may be executed after inputting a search command, and one or more search portal sites may be set as a search engine used by the user. For example, the search engine may include Google, Yahoo, and/or the like.

The controller 180 may display a list of the search results through the search engine on a display screen while performing the search (S104).

When a particular event occurs while displaying the search results, the controller 180 may load web pages linked to one or more results from among the search results based on the particular event (S105, S106). The particular event may be a signal generated by a user input, such as a three-dimensional (3D) browser execution request or a touch drag.

The controller 180 may display the loaded web pages on a display screen (S107).

If the particular event is a 3D browser execution request, then the controller 180 may form a display screen with a polyhedron based on preset information and the controller 180 may display the loaded web pages on each different face of the polyhedron, respectively. The polyhedron may be a geometric solid with flat faces and straight edges. For example, if the controller 180 is set to load three high-rank results from among the search results, then the controller 180 may form a polyhedron made up of four faces when a 3D browser execution is requested. The controller 180 may display a search result list on one face thereof, and the controller 180 may display web pages corresponding to first and second results from among the search results on the faces nearest to the one face being displayed with the search result list. The controller 180 may also display a web page linked to a third result on the remaining one face thereof.

If the particular event is a touch drag, then the controller 180 may display any one of the search results on a display screen. For example, when a touch drag is detected in a direction from right to left, the controller 180 may load a web page linked to a first high-rank result from among the search results and display the web page on the display screen. When a touch drag is detected in a direction from right to left again, the controller 180 may load and display a web page linked to a second high-rank result from among the search results. When a touch drag is detected in a direction from left to right, the controller 180 may again display a web page linked to the first high-rank result from among the search results. In other words, the controller 180 may sequentially display web pages corresponding to each of the search results whenever a touch drag is detected.

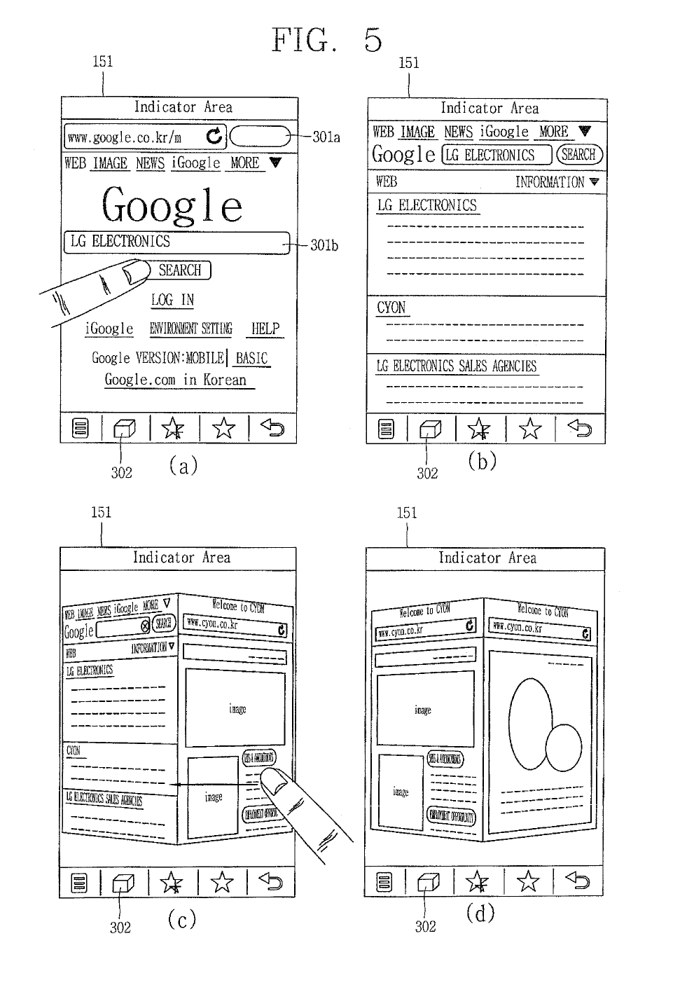

FIG. 5 is a view illustrating an example in which a mobile terminal associated with an example embodiment browses the web or the Internet. In this embodiment, an example may be described in which a 3-dimensional (3D) browser execution is requested.

The controller 180 may execute a browser based on a user's command to access a site providing a preset search engine (i.e., a search portal site). The controller 180 may display a web page provided from the accessed site on a display screen as shown in FIG. 5(a).

When a touch is detected on a search keyword input window 301a of the browser or a search keyword input window 301b of the web page being displayed on the display screen, the controller 180 may switch to a text input mode for entering a search keyword. The controller 180 may display a cursor on the search keyword input window 301a or 301b. In the text input mode, the controller 180 may enter data inputted from the user input unit 130 into the search keyword input window 301a or 301b. For example, as shown in FIG. 5(a), the controller 180 may enter “LG Electronics” as a search keyword into the search keyword input window 301b based on the user's input.

When a search icon is touched as shown in FIG. 5(a), the controller 180 may recognize the touch input as a search command to search data including the inputted search keyword on the web or the Internet. When the search is completed, the controller 180 may display the searched results on the display screen as shown in FIG. 5(b). The controller 180 may display the searched results by classifying them into categories (webs, images, news, blogs, and/or the like).

When a 3D browser execution (i.e., a particular event) is requested while displaying the search results, the controller 180 may form a polyhedron made up of three or more faces to display the web pages. For example, when a touch is detected on an icon 302 allotted for the 3D browser execution, the controller 180 may form a polyhedron made up of a predetermined number of faces by referring to preset 3D browser environment setting information. For example, the controller 180 may load four high-ranking results in an order of high accuracy from among the search results in environment setting information, and the controller 180 may form a polyhedron having five faces. When the polyhedron is formed, the controller 180 may load web pages corresponding to at least one result from among the searched results and display separate web pages on each different face of the polyhedron as shown in FIG. 5(c).

When a touch drag is detected when a polyhedron is displayed having faces each displayed with a web page corresponding to the search result (while executing the 3D browser), the controller 180 may rotate the polyhedron in a drag direction, as shown in FIGS. 5(c) and 5(d). When the rotating polyhedron arrives at a face being displayed with a desired web page, the user may touch and select the relevant face. When a touch input of the user is detected, the controller 180 may display a web page being displayed on the relevant face with 2-dimensions (plane).

FIG. 6 illustrates another example in which a mobile terminal browses the web or the Internet.

As shown in FIG. 6(a), a search portal site (i.e., a search site) may be accessed through a browser, and data including a search keyword inputted by the user in the search site may be searched on the web to display the search result on the display unit 151. When the user performs a touch drag on the display screen displaying the search results, the controller 180 may detect the touch drag by using the sensing unit 140. The controller 180 may determine whether the drag direction is from the right to the left, or from the left to the right. Based on the determined result, the controller 180 may load a web page linked to any one of the searched results and display the web page on the display screen.

For example, if a drag in the direction from the right to the left is detected on the display screen, the controller 180 may load a first high-rank result “LG Electronics” from among the search results and display corresponding information on the display screen as shown in FIG. 6(b). If a drag in the direction from the right to the left is detected again on the screen displaying a web page corresponding to the first result, then the controller 180 may load a web page linked to the second high-rank result from among the search results to display it on the display unit 151 as shown in FIG. 6(c).

On the other hand, if a drag in the direction from the left to the right is detected on the display screen displaying the search result, then the controller 180 may load a web page linked to the first low-rank result from among the search results to display it on the display screen.

FIG. 7 is a view illustrating an example in which a mobile terminal browses the web or the Internet.

The controller 180 may execute a browser based on a user's command to the site and a search engine may be provided based on the user's input. The controller 180 may display a web page provided from the accessed site on the display unit 151 as shown in FIG. 7(a).

When a touch is detected on the search keyword input window 301b of the web page displayed on the display screen, the controller 180 may switch to a text input mode for inputting a search keyword, and the controller 180 may display a cursor on the search keyword input window 301b. In the text input mode, the controller 180 may enter data inputted from the user input unit 130 into the search keyword input window 301b.

When a touch is detected on a search icon in a state that the search keyword input is completed as shown in FIG. 7(a), the controller 180 may regard the touch input as a search command to search data including the search keyword. The controller 180 may output a notifying signal (i.e., a message, an image, etc.) for notifying that the search is in progress.

While performing the search, the controller 180 may divide a data display region 400 of the display screen into at least two screens. When the screen is divided, the controller 180 may display a search result list on any one of the divided regions. The controller 180 may load and display a web page corresponding to any one of the searched results on another divided region. For example, as shown in FIG. 7(b), the controller 180 may divide the data display region 400 into two regions (region 410 and region 420), and the controller 180 may display the search results on either one of the regions 410, 420. The controller 180 may access a site linked to the first result “LG Electronics” from among the search results and then download and display a web page provided from the relevant site on the other one of the regions 410, 420.

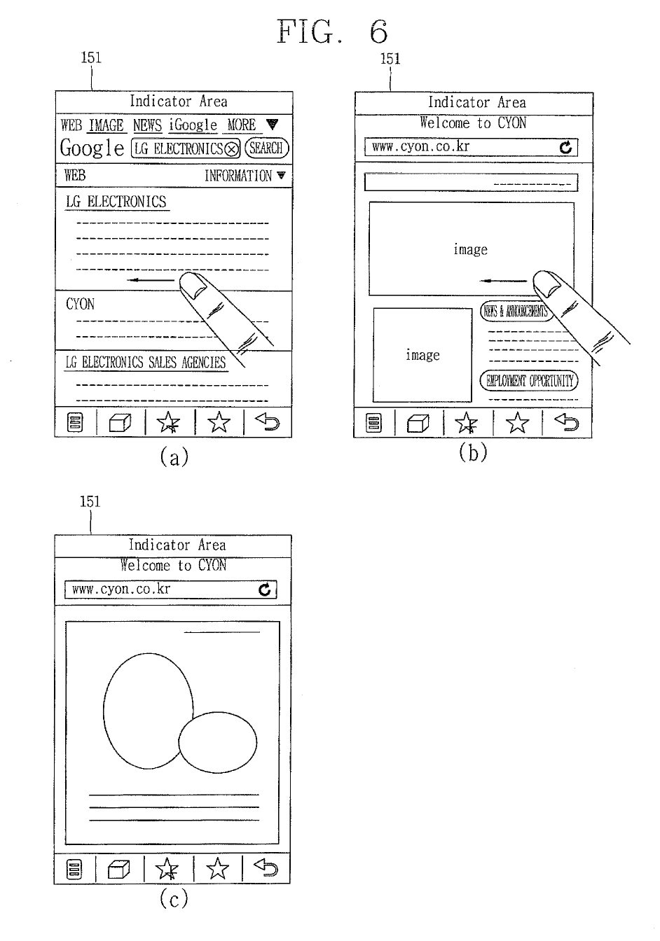

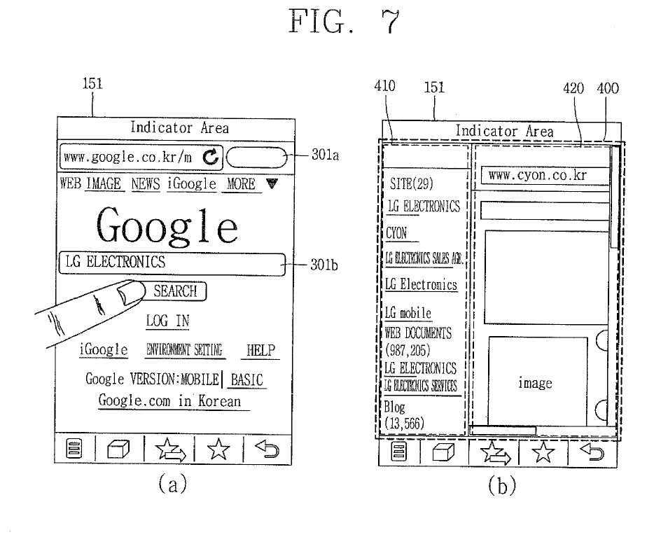

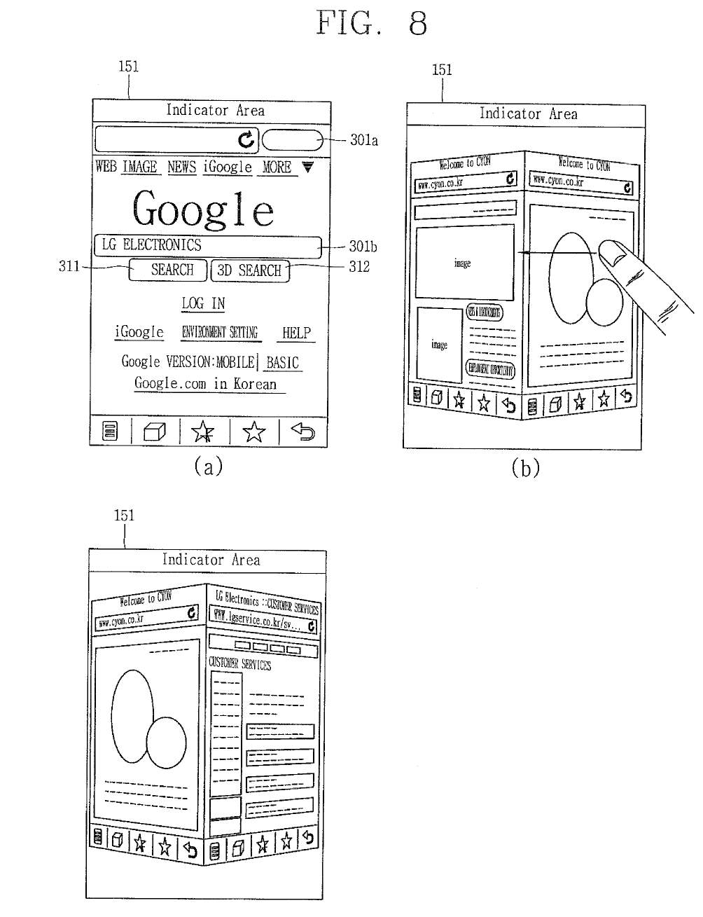

FIG. 8 illustrates an example in which a mobile terminal browses the web or the Internet.

The controller 180 may execute a browser based on a user's command to access the site and a search engine may be provided. The controller 180 may download and display a web page provided from the accessed site on a display screen as shown in FIG. 8(a). In addition to a search icon 311, a 3D search icon 312 for requesting a 3D browser search may be separately provided on the display.

If a search keyword is entered in the search keyword input window 301b and the 3D search icon 312 is selected in the search engine, the controller 180 may search data including the inputted search keyword. While performing the search, the controller 180 may form a polyhedron.

When the search is completed, the controller 180 may load a web page corresponding to one or more results from among the searched results and display the results on each different face of the formed polyhedron as shown in FIG. 8(b). For example, the controller 180 may sequentially display information from a web page with a short loading time from among the web pages linked to the search results on each face of the polyhedron. In other words, if the loading time is in an order of A-site, B-site, and C-site, then an access screen (i.e., a homepage) of the A-site may be loaded and displayed on a first face of the polyhedron, and an access screen of the B-site may be displayed on a second face nearest to the first face being displayed with the accessed screen of the A-site. Further, an access screen of the C-site may be displayed on a third face nearest in parallel to the second face being displayed with the access screen of the B-site.

If a touch drag in a direction from left to right is detected on the display screen that displays a polyhedron having faces each being displayed with a web page linked to the search result, the controller 180 may rotate the polyhedron based on the drag direction as shown in FIG. 8(c).

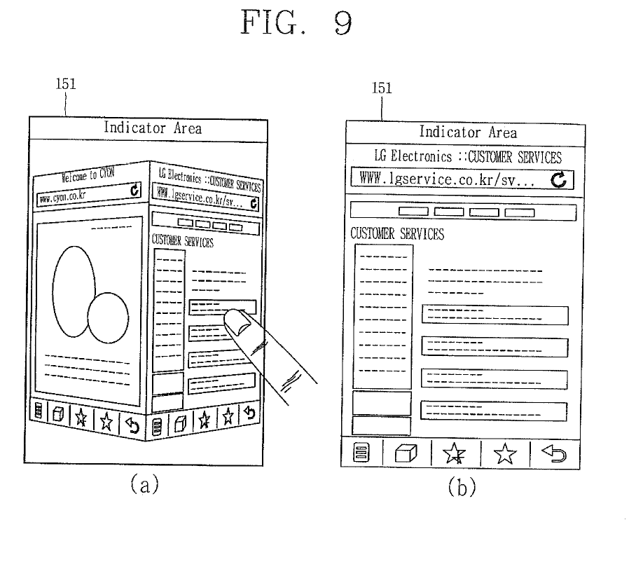

FIG. 9 is a view illustrating an example in which a mobile terminal selects and displays one of the web pages displayed on a polyhedron.

The controller 180 may search data including a particular search keyword based on a user's command, and the controller 180 may then load pages linked to a predetermined number of results from among the search results to display them on each respective face of the polyhedron as shown in FIG. 9(a). If a drag is detected in the horizontal direction on a display screen displaying the polyhedron, then the controller 180 may rotate the polyhedron in the detected drag direction.

When a touch is detected on any one face of the polyhedron while rotating the polyhedron, the controller 180 may display the relevant face with 2-dimensions (2D) as shown in FIG. 9(b). In other words, the controller 180 may display a web page being displayed on the selected face on the full screen.

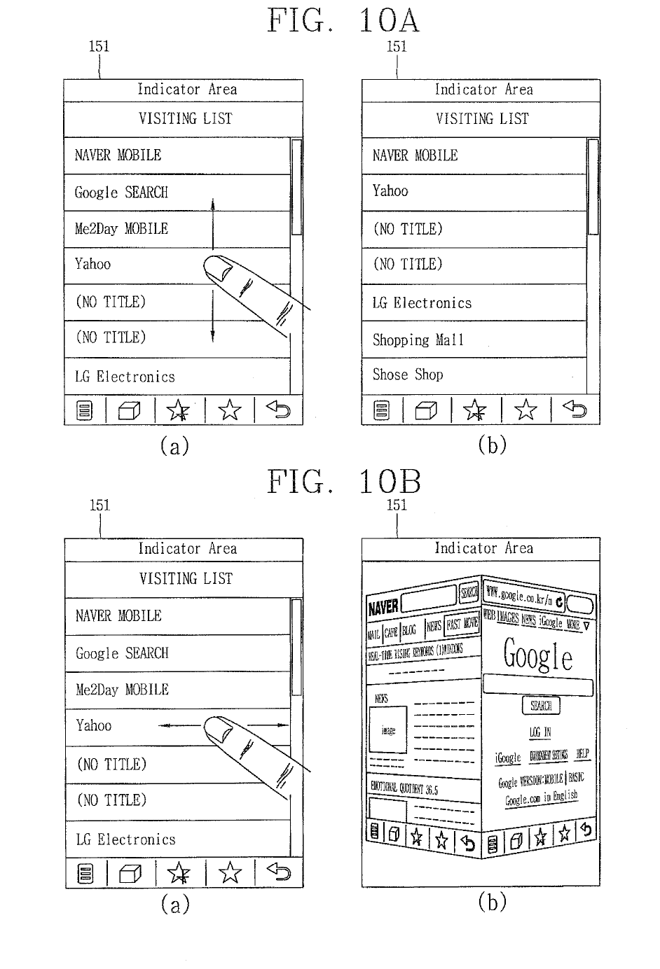

FIGS. 10A and 10B are views illustrating an example in which a mobile terminal controls a display screen based on a touch drag input.

As shown in FIG. 10A, the controller 180 may execute (or perform) a browser, and then the controller 180 may read a visiting list that has been written in the memory 160 when a history menu is selected on an execution screen of the browser to display it on the display screen as shown in FIG. 10A(a). When a touch drag is detected on the display screen displaying the visiting list, the controller 180 may determine the detected drag direction.

If the detected drag is a vertical movement, then the controller 180 may scroll the visiting list based on the drag direction. In other words, the controller 180 may move the visiting list being displayed in the vertical direction based on the drag distance and direction as shown in FIG. 10A(b). A drag input may be described in this embodiment, although the visiting list may be scrolled based on a flicking input. For example, the controller 180 may move the visiting list in a particular direction based on the flicking direction, and the controller 180 may determine the scroll speed and moving distance of the visiting list based on the flicking speed.

Referring to FIG. 10B, the controller 180 may display the visiting list on a display screen based on a user's input as shown in FIG. 10B(a). When a touch drag is inputted on the display screen being displayed with the visiting list, the controller 180 may detect the touch input using the sensing unit 140. If the touch input is a horizontal drag, then the controller 180 may recognize the horizontal drag as a 3D browser execution request.

When the horizontal drag is inputted, the controller 180 may form a polyhedron having two or more faces to be displayed with loaded web pages. The controller 180 may load a web page linked to each item written on the visiting list to display the web page on each different face of the polyhedron respectively as shown in FIG. 10B(b). The controller 180 may load web pages for all items on the visiting list or load web pages for a predetermined number of items on the visiting list. A number of the loaded web pages or a number of faces of the polyhedron may be set by the user or may be determined by the number of items included in the visiting list.

If a horizontal drag is detected on the display screen displaying the polyhedron, then the controller 180 may rotate the polyhedron to the left or to the right based on the detected drag direction.

FIG. 11 is a view illustrating an example in which a mobile terminal performs a multi-search.

Referring to FIG. 11, the controller 180 may execute a browser based on a user's input to access a search portal site. The controller 180 may receive web page information from the search portal site and display the information on a display screen as shown in FIG. 11(a). When the user touches the search keyword input window 301b on an access screen of the search portal site, the controller 180 may enter to a touch input mode and display a cursor on the search keyword input window 301b. If an input is generated by the user, the controller 180 may insert the inputted data into the search keyword input window 301b. When the search keyword input is completed, the controller 180 may search data including the inputted search keyword. When a search icon 310 is touched by the user after inputting a search keyword, the controller 180 may recognize the touch input as a search command to search data including the inputted search keyword.

When the search is completed, the controller 180 may form a polyhedron 430, and display web pages linked to the searched results on each respective face of the polyhedron 430 as shown in FIG. 11(b). For example, if a search keyword “A” is inputted, the controller 180 may search data including the search keyword “A”, and form a polyhedron 430 that displays web pages corresponding to the search results on each respective face of the polyhedron 430 as shown in FIG. 11(b). In other words, the controller 180 may load a web page of the result 1 from among the search result and display it on a face of the polyhedron 430, and load and display a web page of the result 2 on a face adjacent to the face displayed with the result 1.

The controller 180 may return to a screen displaying the search portal site based on the user's control command. The controller 180 may receive a search keyword “B” from the search portal site to enter the search keyword into the search keyword input window 301b as shown in FIG. 11(c). When the input of the search keyword “B” is completed, the controller 180 may search data including the search keyword “B”. When a search icon 310 is selected after inputting the search keyword, the controller 180 may request a data search including the inputted search keyword to a search server. The search server may search data including the search keyword through a search engine and transmit the result to the mobile terminal 100 based on a request of the mobile terminal 100.

When the search is completed, the controller 180 may form a new polyhedron 440, and load web pages linked to the search results for the search keyword “B” and display them on each respective face of the new polyhedron 440 as shown in FIG. 11(d).

If a horizontal drag is detected on a display screen being displayed with the polyhedrons 430, 440, the controller 180 may rotate the polyhedrons 430, 440 corresponding to a position detected by the drag based on the drag direction. When a vertical drag is detected, the controller 180 may scroll (or move) the polyhedrons 430, 440 based on the drag direction.

FIG. 12 is an example illustrating an execution screen of a 3D browser in a mobile terminal.

The controller 180 may perform or execute a browser to access a preset particular site as shown in FIG. 12(a). The controller 180 may download a web page from the accessed site and display the web site on a display screen. If a particular site is not registered in advance, then the controller 180 may display a vacant page.

When a 3D browser execution is requested while displaying the web page, the controller 180 may form a polyhedron and display an execution screen with a different function on each face of the polyhedron. For example, the controller 180 may display a browser execution screen on a first face 451 of the polyhedron, and display a favorites list on a second face 452 of the polyhedron as shown in FIG. 12(b). Further, the controller 180 may display a sites list previously visited by the user on a third face 453 of the polyhedron, and display an environment setting screen on a fourth face 454 of the polyhedron as shown in FIGS. 12(c)-(d).

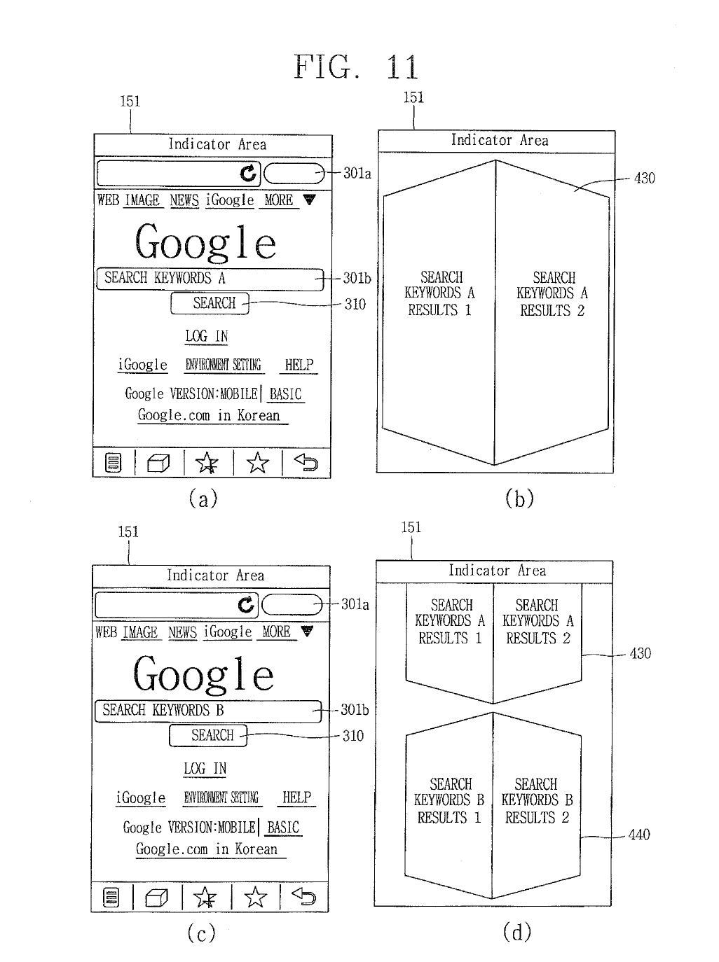

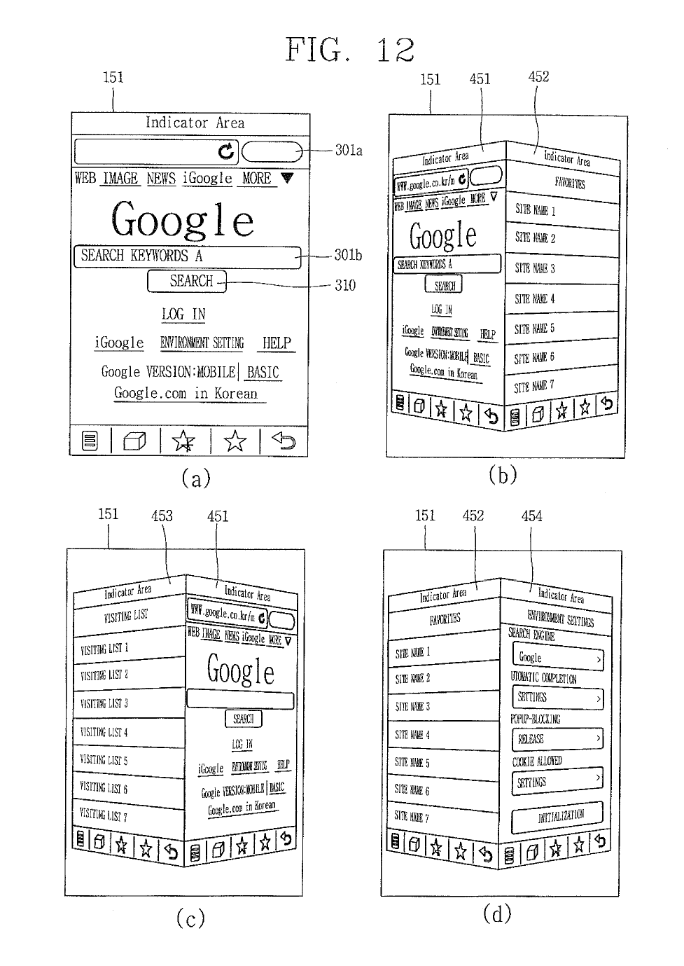

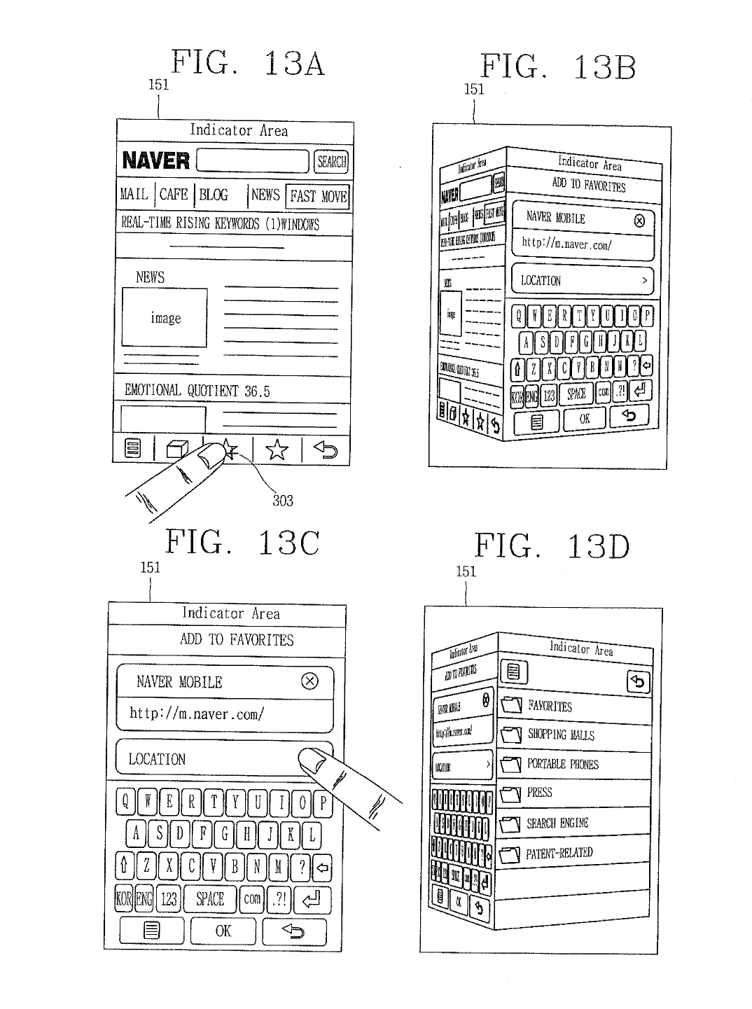

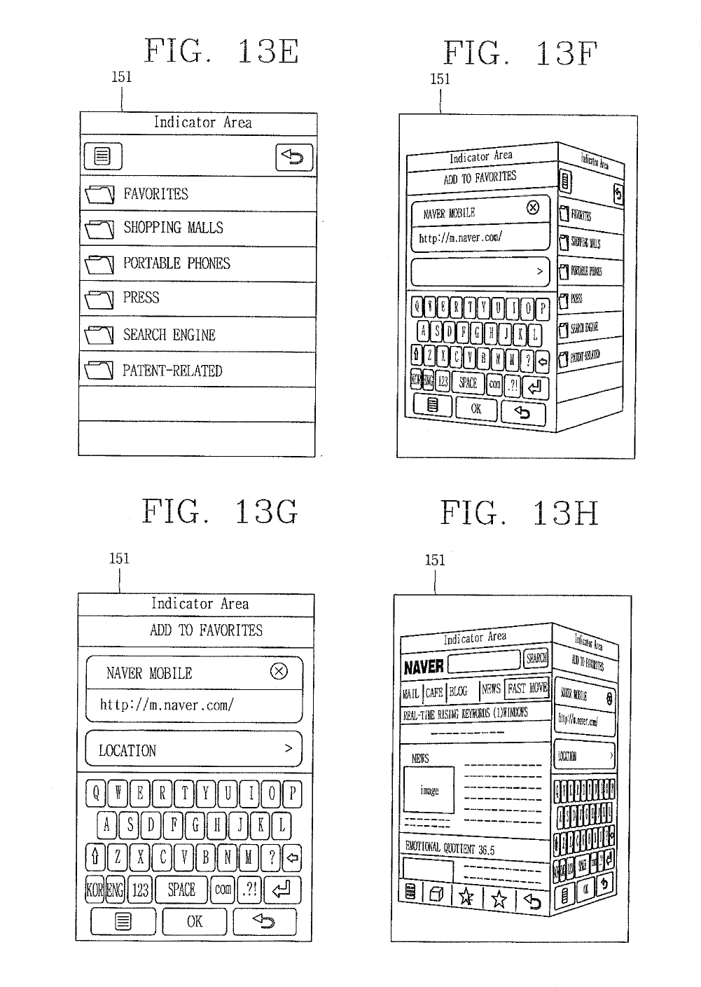

FIG. 13 is an example illustrating adding to favorites on a mobile terminal.

The controller 180 may perform a browser, and access a preset site with a homepage to display a web page provided from the site on the display unit 151 as shown in FIG. 13A. If it is required to register the accessed site into favorites, then the user may select an “add to favorites” menu 303.

If an “add to favorites” is requested by the user, the controller 180 may move it to a relevant face of the polyhedron on which an “add to favorites” screen is displayed as shown in FIG. 13B. The controller 180 may rotate the polyhedron and automatically switch to a relevant face of the polyhedron on which an “add to favorites” screen is displayed when the “add to favorites” is requested, but it may also be possible to form a polyhedron and display an “add to favorites” screen on a face of the polyhedron when an “add to favorites” request is recognized.

When the face being displayed with the “add to favorites” screen is displayed on an entire screen of the display unit 151 by rotating the polyhedron, the controller 180 may enter data inputted by the user into each field on the “add to favorites” screen as shown in FIG. 13C. For example, as shown in FIG. 13C, the controller 180 may enter the title of the favorite page and the address of the relevant site based on the user's input.

Further, when a location field is selected on the “add to favorites” screen, the controller 180 may rotate the polyhedron to display a face being displayed with a group list within the favorites as shown in FIGS. 13D-13E. When any one of the displayed group list within the favorites is selected, the controller 180 may return to the “add to favorites” screen as shown in FIGS. 13F-13G. When an “OK” icon is selected on the “add to favorites” screen, the controller 180 may add the site to the selected group within the favorites.

When the “add to favorites” is completed, the controller 180 may return to a face of the polyhedron being displayed with the site as shown in FIG. 13H.

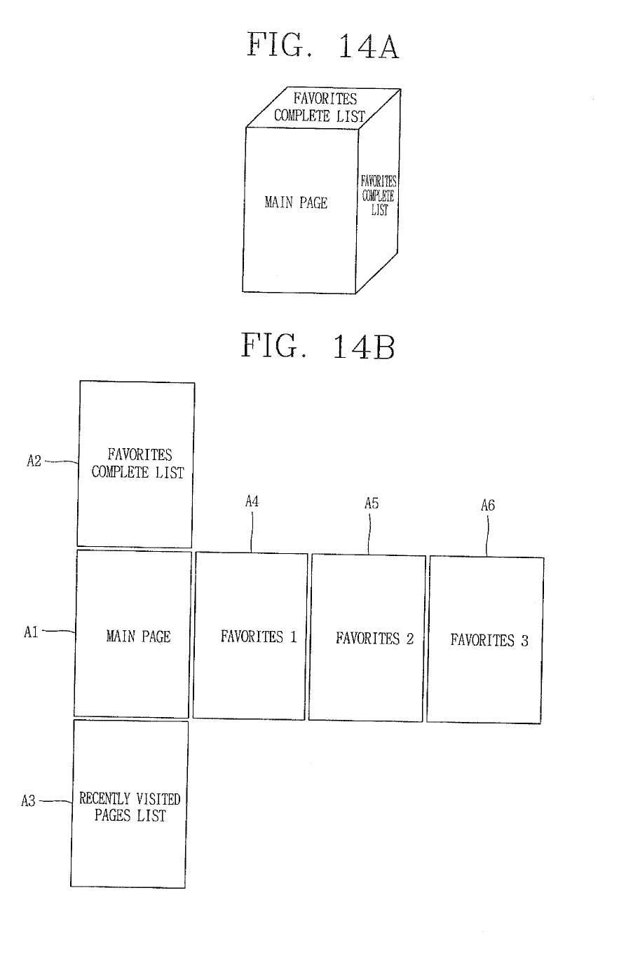

FIGS. 14A-14B are views illustrating an execution screen of the 3D browser in a mobile terminal and an unfolded view thereof.

More specifically, FIG. 14A is a view illustrating an execution screen of the 3D browser displayed with a polyhedron, and FIG. 14B is an unfolded view of the polyhedron. According to the unfolded view of FIG. 14B, a favorites list, a recently visited pages list (visiting list), a web page of the site set as a homepage, web pages with a predetermined number of favorites sites from the registered favorites list on each face of the polyhedron are displayed on each face of the polyhedron, respectively.

A mobile terminal having one of the above configurations may perform a web search and display a list of the searched results, and load web pages linked to a predetermined number of search results from among the searched results, and immediately display the loaded web pages when a 3D browser execution is requested by the user while displaying the search results list, thereby generating no delay time due to the web page loading.

The above-described method may be implemented as codes readable by a computer on a medium written by the program. The computer-readable media may include all types of recording devices in which data readable by a computer system can be stored. Examples of the computer-readable media may include ROM, RAM, CD-ROM, magnetic tape, floppy disk, and optical data storage device, and/or the like, and may also include a device implemented via a carrier wave (for example, a transmission via the Internet). The computer may include the controller 180 of the mobile terminal 100.

Configurations and methods according to the above-described embodiments may not be applicable in a limited way to the foregoing terminal, and all or part of each embodiment may be selectively combined and configured to make various modifications thereto.

Embodiments of the present invention may provide a mobile terminal and browsing method thereof for loading web pages linked to a predetermined number of results from among the results retrieved through a web search.

Embodiments of the present invention may provide a mobile terminal for displaying a web page with a different result on each face of a polyhedron on the display screen when displaying web pages linked to a predetermined number of results from among the search results.

Embodiments of the present invention may provide a mobile terminal for loading and displaying a web page linked to any one of search results based on a touch drag inputted on a screen displaying the search results.

Embodiments of the present invention may provide a mobile terminal for dividing a display screen into a plurality of regions, and displaying search results on one of the divided regions, and loading and displaying any one web page from among the searched results on another region thereof.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A browsing method of a mobile terminal, the method comprising:
executing a browser;
performing a search using the browser;
displaying a list of results from the search on a display screen;
loading web pages corresponding to at least one result from the search; and
displaying the loaded web pages on the display screen in response to a specific event occurring while displaying the list of results from the search.

2. The browsing method of claim 1, wherein performing the search comprises:
inputting a search keyword; and
searching data including the inputted search keyword on the Internet.

3. The browsing method of claim 1, wherein loading the web pages includes loading web pages corresponding to a predetermined number of results from among the results of the search.

4. The browsing method of claim 1, wherein loading the web pages includes loading web pages corresponding to a predetermined number of results in an order based on access frequency from among the results of the search.

5. The browsing method of claim 1, wherein loading the web pages includes loading web pages corresponding to a predetermined number of results in an order based on accuracy from among the results of the search.

6. The browsing method of claim 1, wherein loading the web pages includes loading web pages corresponding to a predetermined number of results in a order based on loading time from among the results of the search.

7. The browsing method of claim 1, wherein the specific event occurs based on an input for a three-dimensional (3D) browser execution.

8. The browsing method of claim 7, wherein displaying the loaded web pages comprises:
forming a display screen with a polyhedron when the input for the 3D browser execution is received; and
displaying a different one of the loaded web pages on each corresponding face of the polyhedron.

9. The browsing method of claim 1, wherein displaying the loaded web pages comprises:
detecting a touch drag while displaying the results of the search; and
displaying any one of the loaded web pages on the display screen in a predetermined order when the touch drag is detected.

10. The browsing method of claim 9, wherein the predetermined order is determined based on a high-rank order or a low-rank order of the results of the search corresponding to the web page based on a touch drag direction.

11. A browsing method of a mobile terminal the method comprising:
executing a browser;
performing a search using the browser;
dividing a display screen into at least two regions; and
displaying a list of results of the search on a first one of the divided regions, and displaying, in a second one of the divided regions, a web page linked to one search result from among the results of the search.

12. A mobile terminal, comprising:
a wireless communication unit to access the Internet;
an input unit to input a search keyword; and
a controller to search data including the inputted search keyword and to display a list of results of the search on a display screen, and the controller to load web pages corresponding to at least one of the search results and to display the loaded web pages on the display screen in response to a specific event occurring while displaying the list of the results from the search.

13. The mobile terminal of claim 12, wherein the controller displays the loaded web pages on each face of a polyhedron respectively when a three-dimensional (3D) browser execution is requested while displaying the results of the search.

14. The mobile terminal of claim 12, wherein the controller displays the loaded web pages on each face of a polyhedron respectively when a touch drag is detected in a horizontal direction on the display screen displaying the results of the search.

15. The mobile terminal of claim 14, wherein the controller scrolls the results of the search displayed on the display screen when the touch drag is detected in a vertical direction.

16. The mobile terminal of claim 12, wherein the specific event is an input for a three-dimensional browser execution.

17. The mobile terminal of claim 12, wherein the controller divides the display screen into at least two regions, and displays a list of the results of the search on a first one of the divided regions, and the controller loads and displays, on a second one of the divided regions, a web page linked to one of the results of the search.

18. The mobile terminal of claim 12, wherein results of the search are displayed based on a high-rank order or a low-rank order.

19. The mobile terminal of claim 12, wherein results of the search are displayed based on an accuracy order.

20. The mobile terminal of claim 12, wherein results of the search are displayed based on a loading time order.
